(19) United States
(12) Patent Application Publication
(10) Pub. No.: US 2023/0290284 A1
(43) Pub. Date: Sep. 14, 2023

(54) AERIAL IMAGE DISPLAY DEVICE AND INPUT DEVICE

(71) Applicant: NIDEC SANKYO CORPORATION, Nagano (JP)

(72) Inventors: Shinya MIYAZAWA, Nagano (JP); Yosuke OGUCHI, Nagano (JP); Junro TAKEUCHI, Nagano (JP); Masaya FUJIMOTO, Nagano (JP); Tsutomu BABA, Nagano (JP)

(21) Appl. No.: 18/016,787

(22) PCT Filed: Apr. 28, 2021
(86) PCT No.: PCT/JP2021/016981

§ 371 Date: Jan. 18, 2023

Related U.S. Application Data
(60) Provisional application No. 63/054,799, filed on Jul. 22, 2020.

(30) Foreign Application Priority Data
Jan. 26, 2021 (JP) 2021-010026

(51) Int. Cl. G09G 3/00; G06F 3/03

(52) U.S. Cl. CPC G09G 3/001; G06F 3/0304; G09G 2354/00

(57) ABSTRACT

An aerial image display device includes a display mechanism having a display surface for displaying images, an aerial-image forming mechanism which projects the image displayed on the display surface into a space to form an image as an aerial image, and an enclosure in which the display mechanism and the aerial-image forming mechanism are accommodated. To the enclosure, wall portions rising from at least a part of a periphery of the aerial-image display region, which is a region where an aerial image is formed, are fixed.

### CROSS REFERENCE TO RELATED APPLICATIONS

This is the U.S. national stage of application No. PCT/JP2021/016981, filed on Apr. 28, 2021. Priority under 35 U.S.C. § 365(b) is claimed from Japanese Application No. 2021-010026, filed Jan. 1, 2021, and priority under 35 U.S.C. § 119(e) is claimed to U.S. Provisional Application No. 63/054,799, filed Jul. 22, 2020, the disclosure of which is also incorporated herein by reference.

### TECHNICAL FIELD

The present invention relates to an aerial image display device that displays aerial images in a three-dimensional space. The present invention also relates to an input device including the aerial image display device as above.

### BACKGROUND ART

Conventionally, aerial image display devices that display aerial images in a three-dimensional space are known (see, Patent Literature 1, for example). The aerial image display device described in Patent Literature 1 is mounted and used in ATMs (Automated Teller Machines) and other automated transaction devices. This aerial image display device includes a display portion main-body having a display surface for displaying images and an aerial-image forming mechanism that projects the image displayed on the display surface of the display portion main-body into a space to form an image as an aerial image. In the aerial image display device described in Patent Literature 1, the aerial image is formed above or in front of the aerial-image forming mechanism.

### CITATION LIST

### Patent Literature

[Patent Literature 1] Japanese Unexamined Patent Application Publication 2020-134843

### SUMMARY OF THE INVENTION

### Problems to be Solved by the Invention

In the aerial image display device described in Patent Literature 1, the aerial image is formed in the three-dimensional space and thus, the aerial image is easily affected by external light. When the aerial image is affected by the external light, the aerial image becomes less visible. In particular, when this aerial image display device is installed outdoors, the aerial image is more susceptible to external light, and there is a concern that the aerial image becomes less visible.

Thus, an object of at least an embodiment of the present invention is to provide, in an aerial image display device including an aerial-image forming mechanism that projects an image displayed on a display surface of a display mechanism into a space to form an image as an aerial image, an aerial image display device that can ensure visibility of the aerial image by reducing an influence of the external light on the aerial image. Moreover, an object of at least an embodiment of the present invention is to provide an input device including the aerial image display device as above.

### Means for Solving the Problem

In order to solve the above problem, an aerial image display device of an aspect of the present invention is characterized by including a display mechanism having a display surface which displays an image, an aerial-image forming mechanism that projects the image displayed on the display surface into a space to form an image as an aerial image, and an enclosure in which the display mechanism and the aerial-image forming mechanism are accommodated, and in the enclosure, a wall portion rising from at least a part of a periphery of an aerial-image display region, which is a region in which the aerial image is formed, is formed or fixed.

In the aerial image display device in this aspect, the wall portion rising from at least a part of the periphery of the aerial-image display region is formed on or fixed to the enclosure in which the display mechanism and the aerial-image forming mechanism are accommodated. Thus, in this aspect, the influence of the external light on the aerial image formed in the aerial-image display region can be reduced by the wall portion. Therefore, in this aspect, visibility of the aerial image can be secured. In addition, in this aspect, peeking or peeping at the aerial image formed in the aerial-image display region by a person other than a user who uses the aerial image display device can be suppressed by the wall portion.

In this aspect, for example, the enclosure has a frame body surrounding the aerial-image display region, an inner peripheral side of the frame body is an opening portion leading to an inside of the enclosure, and the wall portion is formed on or fixed to the frame body.

In this aspect, it is preferable that the opening portion is formed having a rectangular or a regular-square shape, and the wall portion is disposed along an edge of the opening portion and surrounds the opening portion from four or three directions. By configuring as above, the influence of the external light on the aerial image can be effectively reduced by the wall portion surrounding the opening portion from four or three directions.

In this aspect, the aerial image display device preferably includes a shutter member for closing the opening portion and a shutter drive mechanism moving the shutter member between a closed position where the opening portion is closed and an open position where the opening portion is opened. By configuring as above, the opening portion can be closed by the shutter member when the aerial image display device is not in use. Therefore, it is possible to reduce an amount of dust and other particles that enter the enclosure through the opening portion, and as a result, degradation of an aerial image quality caused by the influence of the dust and other particles on the display mechanism and the aerial-image forming mechanism can be suppressed. In addition, since breakage or the like of the display mechanism or the aerial-image forming mechanism due to tampering or the like can be suppressed, the degradation of the aerial image quality caused by the breakage or the like of the display mechanism or aerial-image forming mechanism can be suppressed.

In this aspect, the aerial image display device preferably includes a fan which is disposed inside the enclosure and circulates air inside the enclosure. By configuring as above, generation of mold inside the enclosure can be suppressed, even when the aerial image display device is used in an environment with high humidity. Therefore, the degradation of the aerial image quality caused by mold that is generated inside the enclosure can be suppressed.

In this aspect, it is preferable that the aerial-image forming mechanism includes a beam splitter which reflects a part of light emitted from the display surface and a retroreflective material to which the light reflected by the beam splitter is incident and which reflects the incident light in the same direction as an incident direction toward the beam splitter, and after reflecting the light by the retroreflective material, an aerial image is formed by the light transmitted through the beam splitter in the aerial-image display region, and the display surface faces diagonally downward. By configuring as above, since the display surface faces diagonally downward, dust and other particles less likely adhere to the display surface. In addition, even if the aerial image display device is installed outdoors, rainwater or the like less likely adheres to the display surface. Therefore, the degradation of the aerial image quality caused by the dust and the like adhering to the display surface can be suppressed.

In this aspect, it is preferable that the beam splitter is formed as a flat plate and reflects, diagonally downward, a part of the light emitted from the display surface, the retroreflective material reflects the incident light diagonally upward, and the display mechanism is disposed out of the field of view of the user viewing the aerial image. By configuring as above, the image displayed on the display surface is not directly visible to the user viewing the aerial image, and the user does not see any more the aerial image overlapping the image displayed on the display surface. Therefore, the user can clearly recognize the aerial image. Moreover, by configuring as above, an inclination angle of the beam splitter relative to a horizontal direction can be made larger and thus, dust, rainwater and the like less likely adhere to an upper surface of the beam splitter because of an action of gravity.

The aerial image display device of this aspect is an input device inputting information using a user's fingertip, including a detection mechanism detecting a position of the user's fingertip in the aerial-image display region, and the aerial-image display region can be used in the input device, which is an input portion for the user to input the information. With this input device, the influence of the external light on the aerial image can be reduced, and visibility of the aerial image can be ensured. In addition, with this input device, peeking or peeping of an input operation in the input portion by a person other than the user performing the input operation in the input portion can be suppressed.

In this aspect, it is preferable that the enclosure includes a frame body surrounding the aerial-image display region, the inner peripheral side of the frame body is an opening portion leading to an inside of the enclosure and is also an input portion, and at least a part of the edge of the opening portion is formed of a grounded conductive member. By configuring as above, static electricity emitted by the user when the user performs the input operation in the input portion can be released by using the conductive member. Therefore, breakage of a component of the input device caused by static electricity emitted by the user when the user performs the input operation in the input portion can be prevented.

### Effect of the Invention

As described above, in at least an embodiment of the present invention, in an aerial image display device including an aerial-image forming mechanism that projects an image displayed on the display surface of the display mechanism into a space to form the image as an aerial image, the influence of the external light on the aerial image can be reduced, and the visibility of the aerial image can be ensured.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a perspective view of an input device according to an embodiment of the present invention.

FIG. 2 is a schematic diagram for explaining a configuration of an aerial image display device used in the input device shown in FIG. 1.

FIG. 3A and FIG. 3B are diagrams for explaining a configuration of the input device shown in FIG. 1.

FIG. 4 is a diagram illustrating an example of an aerial image displayed in an aerial-image display region shown in FIG. 1.

### MODE FOR CARRYING OUT THE INVENTION

In the following, embodiments of the present invention will be described with reference to the drawings.

Configuration of Input Device and Aerial-Image Display Device

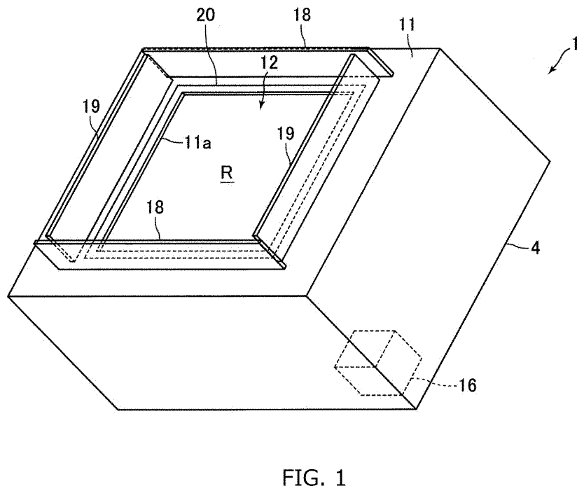

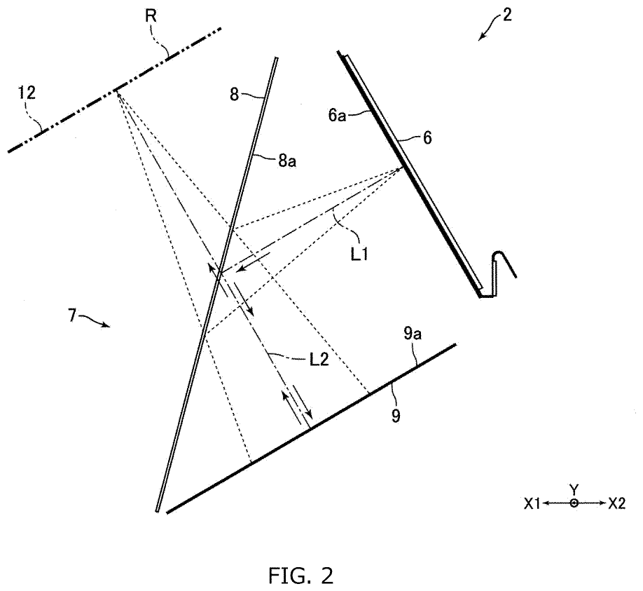

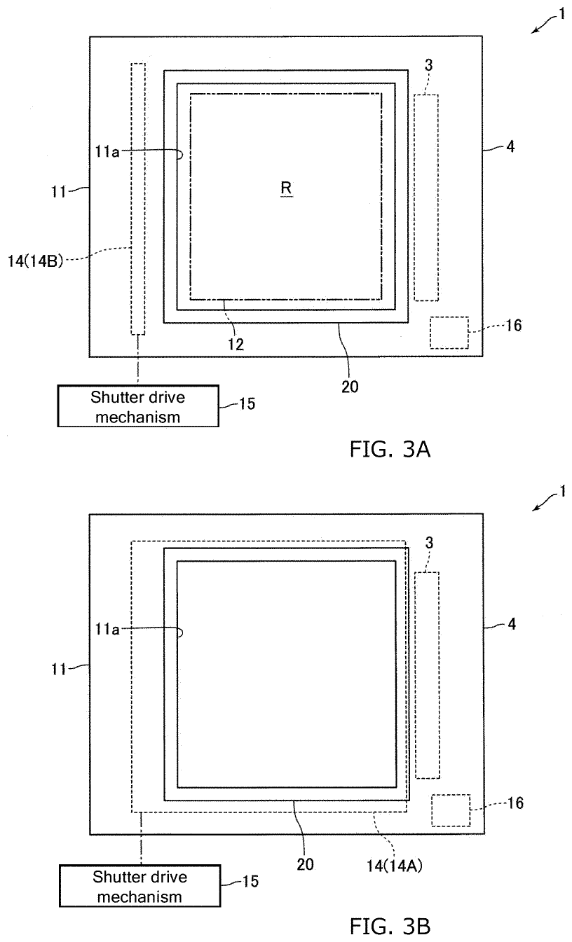

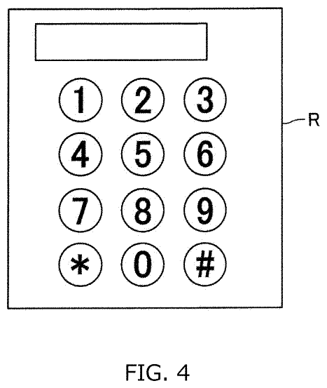

FIG. 1 is a perspective view of an input device 1 according to an embodiment of the present invention. FIG. 2 is a schematic diagram for explaining a configuration of an aerial image display device 2 used in the input device 1 shown in FIG. 1. FIG. 3A and FIG. 3B are diagrams for explaining a configuration of the input device 1 shown in FIG. 1. FIG. 4 is a diagram illustrating an example of an aerial image displayed in an aerial-image display region R shown in FIG. 1.

The input device 1 in this embodiment is a device inputting information using a user's fingertips and is used by ATMs, authentication devices for credit card and other payments, automatic ticketing machines, vending machines, or access control devices, for example. In the input device 1, a PIN is input, for example. The input device 1 has the aerial image display device 2 which displays an aerial image in a three-dimensional space and a detection mechanism 3 for detecting a position of the user's fingertip in the aerial-image display region R, which is a region in which the aerial image is displayed. Information other than the PIN may be input in the input device 1. For example, the user's signature (signature) may be input in the input device 1.

The aerial image display device 2 has a display mechanism 6 having a display surface 6a for displaying images, and an aerial-image forming mechanism 7 which projects the image displayed on the display surface 6a into a space to form an image as an aerial image, and an enclosure 4 in which the display mechanism 6 and the aerial-image forming mechanism 7 are accommodated. The aerial-image forming mechanism 7 has a beam splitter 8 and a retroreflective material 9. The aerial image display device 2 also includes a shutter member 14 for closing an opening portion 11a described below, which is formed in the enclosure 4, a shutter drive mechanism 15 for moving the shutter member 14, and a fan 16 disposed inside the enclosure 4.

In the following explanation, a Y-direction in FIG. 2, which is orthogonal to an up-down direction (vertical direction), is referred to as a left-right direction, and a direction orthogonal to the up-down direction and the left-right direction is referred to as a front-back direction. Moreover, an X1-direction side in FIG. 2, which is one side in the front-back direction, is assumed to be a “front” side, and an X2-direction side in FIG. 2, which is a side opposite to that, is assumed to be a “back” side. In this embodiment, a user standing on a front side of the input device 1 inputs predetermined information on a front surface side of the input device 1.

The display mechanism 6 is, for example, a liquid crystal display or an organic EL display, and the display surface 6a is a display screen. The display surface 6a faces diagonally downward. Specifically, the display surface 6a faces diagonally forward and downward. By assuming that a clockwise direction in FIG. 2 is a “clockwise direction”, the display surface 6a is tilted approximately by 60° in the clockwise direction with respect to the front-back direction when viewed from the left-right direction.

The beam splitter 8 is formed having a flat plate shape. The beam splitter 8 is disposed on the front side of the display mechanism 6. The beam splitter 8 reflects a part of light emitted from the display surface 6a. That is, a surface on one side of the beam splitter 8 is a reflective surface 8a which reflects a part of the light emitted from the display surface 6a. The reflective surface 8a faces diagonally downward. Specifically, the reflective surface 8a faces diagonally rearward and downward. By assuming that the counterclockwise direction in FIG. 2 is a “counterclockwise direction”, the reflective surface 8a is tilted approximately by 75° in the counterclockwise direction with respect to the front-back direction when viewed from the left-right direction. In other words, when viewed from the left-right direction, the flat-plate shaped beam splitter 8 is tilted approximately by 75° in the counterclockwise direction with respect to the front-back direction.

The retroreflective material 9 is formed having a flat plate shape. The retroreflective material 9 is disposed on a lower side of the display mechanism 6 and is disposed on a rear side of the beam splitter 8. To the retroreflective material 9, the light reflected by the beam splitter 8 is incident. The retroreflective material 9 reflects the incident light in the same direction as an incident direction toward the beam splitter 8. In other words, a surface on one side of the retroreflective material 9 is a retroreflective surface 9a, to which the light reflected by the beam splitter 8 is incident and which reflects the incident light in the same direction as the incident direction toward the beam splitter 8.

A quarter-wavelength plate is attached to the retroreflective surface 9a. The retroreflective surface 9a faces diagonally upward. Specifically, the retroreflective surface 9a faces diagonally forward and upward. When viewed from the left-right direction, the retroreflective surface 9a is tilted approximately by 30° in the counterclockwise direction with respect to the front-back direction. In other words, when viewed from the left-right direction, the flat-plate shaped retroreflective material 9 is tilted approximately by 30° in the counterclockwise direction with respect to the front-back direction.

A part of the light emitted from the display surface 6a of the display mechanism 6 is reflected by the reflective surface 8a of the beam splitter 8 and enters the retroreflective surface 9a of the retroreflective material 9. The reflective surface 8a faces diagonally downward, and the light reflected by the reflective surface 8a goes diagonally downward. In other words, the beam splitter 8 reflects, diagonally downward, a part of the light emitted from the display surface 6a. Specifically, the beam splitter 8 reflects a part of the light emitted from the display surface 6a diagonally rearward and downward. In this embodiment, an optical axis L1 of the light emitted from the display surface 6a and an optical axis L2 of the light reflected by the beam splitter 8 are orthogonal.

The light incident to the retroreflective surface 9a is reflected in the same direction as the incident direction of the light to the retroreflective surface 9a. The retroreflective surface 9a faces diagonally upward, and the light reflected by the retroreflective surface 9a goes diagonally upward. In other words, the retroreflective material 9 reflects the incident light diagonally upward. Specifically, the retroreflective material 9 reflects the incident light diagonally forward and upward. The optical axis of the light reflected by the retroreflective material 9 matches the optical axis L2. The light reflected by the retroreflective material 9 is transmitted through the beam splitter 8. The light transmitted through the beam splitter 8 forms an aerial image in the aerial-image display region R.

The aerial-image display region R is formed on a diagonally upper front side of the beam splitter 8. In the aerial-image display region R, for example, a keypad for inputting a PIN is displayed as an aerial image, as shown in FIG. 4. The aerial image is displayed at the position where the display surface 6a is mirror-reversed with respect to the beam splitter 8. The aerial image formed in the aerial-image display region R is recognized by a user standing on the front side of the input device 1 as an image slightly tilted in the up-down direction and the front-back direction. Specifically, the aerial image formed in the aerial-image display region R is recognized by the user standing on the front side of the input device 1 as an image tilted approximately by 30° in the counterclockwise direction with respect to the front-back direction.

In this embodiment, the display mechanism 6 is disposed in a range out of the field of view (field of vision) of the user viewing the aerial image formed in the aerial-image display region R. In other words, the display mechanism 6 is disposed in the range out of the field of view of the user viewing the aerial image formed in the aerial-image display region R by looking into the aerial-image display region R from the front side of the input device 1 diagonally rearward and downward. Specifically, the display mechanism 6 is disposed diagonally behind and above the field of view of the user viewing the aerial image in the aerial-image display region R.

The enclosure 4 is formed, for example, having a cuboid box shape. The enclosure 4 includes a frame body 11 that surrounds the aerial-image display region R. The frame body 11 is formed having a rectangular or regular-square frame shape and is formed having a flat plate shape. The frame body 11 is tilted approximately by 30° in the counterclockwise direction with respect to the front-back direction when viewed from the left-right direction. In other words, the frame body 11 is tilted by the same degree in the same direction as the aerial image formed in the aerial-image display region R with respect to the front-back direction when viewed from the left-right direction. The frame body 11 constitutes a surface on an upper front side of the enclosure 4. An inner peripheral side of the frame body 11 is an opening portion 11a that leads to an inside of the enclosure 4.

The opening portion 11a is formed having a rectangular or regular-square shape. Two of the four sides of the opening portion 11a formed having a rectangular or regular-square shape are parallel to the left-right direction. That is, a lower front edge of the opening portion 11a and an upper rear edge of the opening portion 11a are parallel to the left-right direction. The aerial-image display region R is formed in the opening portion 11a. The aerial-image display region R serves as an input portion 12 for the user to input information. In other words, the inner peripheral side of the frame body 11 is the input portion 12 for inputting information using the user's fingertips. In this embodiment, for example, the PIN is input by using a keypad displayed in the aerial-image display region R.

Wall members 18 and 19 are fixed to the frame body 11 as wall portions rising from the periphery of the aerial-image display region R. In other words, the wall members 18, 19 as the wall portions rising from the periphery of the aerial-image display region R are fixed to the enclosure 4. In this embodiment, two pieces of the wall member 18 and two pieces of the wall member 19 are fixed to the frame body 11. The wall members 18, 19 are formed having a rectangular flat-plate shape, for example. The wall members 18, 19 are fixed to surfaces on an outer side of the frame body 11 (surfaces facing diagonally forward and upward). The wall members 18, 19 protrude diagonally forward and upward from the surfaces on the outer side of the frame body 11. In other words, the wall members 18, 19 extend from the surfaces on the outer side of the frame body 11 to a user side using the input device 1. In FIGS. 3A and 3B, the wall members 18, 19 are not shown.

One wall member 18 of the two pieces of the wall members 18 is disposed along the front the lower front edge of the opening portion 11a, and the other wall member 18 is disposed along the upper rear edge of the opening portion 11a. The wall members 19 are disposed along edges on both ends in the left-right direction of the opening portion 11a. In other words, the wall members 18, 19 are disposed along the edges of the opening portion 11a and surround the opening portion 11a from four directions. In addition, a longitudinal direction of the wall member 18, which is formed having a rectangular flat-plate shape, is parallel to a direction in which the lower front edge or the upper rear edge of the opening portion 11a is formed (that is, the left-right direction), and the longitudinal direction of the wall member 19, which is formed having a rectangular flat-plate shape, is parallel to a direction in which the edges on the both ends in the left-right direction of the opening portion 11a is formed.

The frame body 11 has a frame-shaped conductive member 20 that constitutes the edge of the opening portion 11a. In other words, the frame body 11 includes the conductive member 20 that constitutes an inner peripheral end part of the frame body 11. The conductive member 20 is formed having a rectangular or regular-square frame shape and is formed as a flat plate shape. The conductive member 20 is grounded. In other words, the edge of the opening portion 11a is formed by the grounded conductive member 20. The conductive member 20 is formed, for example, by a resin material with conductivity. The conductive member 20 may be formed of a metallic material.

The detection mechanism 3 is accommodated in the enclosure 4. The detection mechanism 3 detects a position of the user's fingertip in the aerial-image display region R, as described above. In other words, the input portion 12 is included in a detection range of the detection mechanism 3. The detection mechanism 3 is an optical sensor. Specifically, the detection mechanism 3 is an infrared sensor. In addition, the detection mechanism 3 is a line sensor. The detection mechanism 3 includes a light emitting portion which emits infrared light and a light receiving portion to which the infrared light emitted from the light emitting portion and reflected by the user's fingertip is incident. The detection mechanism 3 is disposed on the side of the opening portion 11a. The detection mechanism 3 detects the position of the user's fingertip in a plane containing the aerial-image display region R (that is, in the plane containing the input portion 12).

The fan 16 is disposed inside the enclosure 4, as described above. The fan 16 circulates air inside the enclosure 14. The shutter member 14 and shutter drive mechanism 15 are disposed inside the enclosure 4. The shutter member 14 is constituted by a plurality of flat plates each having an elongated rectangular shape, for example. The shutter member 14 is movable between a closed position 14A (see FIG. 3B), which closes the opening portion 11a, and an open position 14B (see FIG. 3A), which opens the opening portion 11a. In FIG. 1, the shutter member 14 is not shown.

The shutter drive mechanism 15, for example, includes two belts to which each of both end parts of the plurality of flat plates constituting the shutter member 14 are fixed, a plurality of pulleys over which the belts are extended, a motor for rotating a drive pulley in the plurality of pulleys, and a power transmission mechanism which connects the motor and the drive pulley. When the input device 1 is in use, the shutter member 14 is disposed at the open position 14B, and the opening portion 11a is open. On the other hand, when the input device 1 is not in use, the shutter member 14 is disposed at the closed position 14A, and the opening portion 11a is closed.

In the input device 1 configured as described above, information such as a PIN is input by sequentially moving the fingertip to a position of a predetermined key (number) in the keypad displayed as an aerial image in the aerial-image display region R, for example. In other words, the user sequentially moves his/her fingertip in the input portion 12 and inputs the information such as the PIN. The information input in the input portion 12 is recognized on the basis of a detection result of the detection mechanism 3 (that is, the detection result of the position (movement) of the user's fingertip).

Main Effect of this Embodiment

As explained above, in this embodiment, the wall members 18, 19 rising from the periphery of the aerial-image display region R are fixed to the enclosure 4. Thus, in this embodiment, the influence of external light on the aerial image formed in the aerial-image display region R can be reduced by the wall members 18, 19. Therefore, in this embodiment, visibility of the aerial image formed in the aerial-image display region R can be secured. In addition, in this embodiment, since the input portion 12 is surrounded by the wall members 18, 19, the wall members 18, 19 can suppress peeking or peeping of an input operation by a person other than the user who inputs information such as PINs in the input device 1.

In this embodiment, the wall members 18 and 19 surround the opening portion 11a from the four directions. Thus, in this embodiment, the influence of the external light on the aerial image formed in the aerial-image display region R can be effectively reduced by the wall members 18, 19. In addition, peeking or peeping of the input operation by a person other than the user who inputs the information such as PINs in the input device 1 can be effectively suppressed by the wall members 18, 19.

In this embodiment, the shutter member 14 is movable between the closed position 14A, which closes the opening portion 11a, and the open position 14B, which opens the opening portion 11a, and when the input device 1 is not in use, the opening portion 11a is closed by the shutter member 14. Therefore, in this embodiment, it is possible to reduce an amount of dust and other particles that enter the enclosure 4 through the opening portion 11a, and as a result, degradation of an aerial image quality caused by the influence of the dust and other particles on the display mechanism 6 and the aerial-image forming mechanism 7 can be suppressed. In addition, in this embodiment, since breakage or the like of the display mechanism 6 or the aerial-image forming mechanism 7 due to tampering or the like can be suppressed, the degradation of the aerial image quality caused by the breakage or the like of the display mechanism 6 or the aerial-image forming mechanism 7 can be suppressed.

In this embodiment, the fan 16 is disposed inside the enclosure 4, and the fan 16 circulates the air inside the enclosure 4. Thus, in this embodiment, even if the input device 1 is used in an environment with high humidity, it is possible to suppress generation of mold inside the enclosure 4. Therefore, in this embodiment, the degradation of the aerial image quality caused by mold that is generated inside the enclosure 4 can be suppressed.

In this embodiment, the display surface 6a of the display mechanism 6 faces diagonally downward. Thus, in this embodiment, dust and other particles less likely adhere to the display surface 6a. In addition, even if the input device 1 is installed outdoors, rainwater or the like less likely adheres to the display surface 6a. Therefore, in this embodiment, the degradation of the aerial image quality caused by the dust and the like adhering to the display surface 6a can be suppressed.

In this embodiment, the display mechanism 6 is disposed at a position out of the field of view of the user viewing the aerial image. Thus, in this embodiment, the image displayed on the display surface 6a is not directly visible to the user viewing the aerial image, and the user does not see the aerial image overlapping the image displayed on the display surface 6a. Therefore, in this embodiment, the user can clearly recognize the aerial image and, as a result, can input appropriate information in the input portion 12.

In addition, in this embodiment, the display mechanism 6 is disposed at the position out of the field of view of the user viewing the aerial image and thus, an inclination angle of the beam splitter 8 formed having a flat plate shape with respect to the horizontal direction can be made larger. In other words, in this embodiment, the inclination of the beam splitter 8 to the front-back direction can be approximately 75° when viewed from the left-right direction, as described above. Therefore, in this embodiment, dust, rainwater, and the like less likely adhere to an upper surface of the beam splitter 8 (a surface on a side opposite to the reflective surface 8a) due to the action of gravity.

In this embodiment, the edge of the opening portion 11a on the inner peripheral side of the frame body 11 is formed by the grounded conductive member 20, and the input portion 12 is surrounded by the grounded conductive member 20. Thus, in this embodiment, static electricity emitted from the user when the user performs the input operation in the input portion 12 can be released by using the conductive member 20. Therefore, in this embodiment, breakage of a component of the input device 1 caused by the static electricity emitted by the user when the user performs the input operation in the input portion 12 can be prevented.

### Other Embodiments

The embodiment described above is an example of a preferred embodiment of the present invention but it is not limiting, and various modifications can be made within a range not changing the gist of the present invention.

In the embodiment described above, the opening portion 11a may be surrounded by the wall members 18, 19 from three directions. Moreover, in the embodiment described above, the opening portion 11a may be surrounded by the wall members 18, 19 from two directions, or only one wall member 18 or one wall member 19 may be fixed to the frame body 11. In other words, to the frame body 11, the wall members 18 and 19 rising from a part of the periphery of the aerial-image display region R may be fixed.

When the opening portion 11a is surrounded by the wall members 18, 19 from three directions, the opening portion 11a is preferably surrounded from the three directions by the wall member 18, which is disposed along an edge on the upper rear end of the opening portion 11a, and by two wall members 19, which are disposed along edges on the both ends in the left-right direction of the opening portion 11a. In this case, even though the opening portion 11a is surrounded by the wall members 18, 19 from three directions, the wall members 18, 19 can effectively reduce the influence of external light on the aerial image formed in the aerial-image display region R, and peeking or peeping of an input operation by a person other than the user who inputs information such as a PIN in the input device 1 can be effectively suppressed by the wall members 18, 19.

Moreover, when the opening portion 11a is surrounded by the wall members 18, 19 from two directions, or when only one wall member 18 or one wall member 19 is fixed to the frame body 11, the wall member 18 disposed along the edge on the upper rear end of the opening portion 11a is preferably fixed to the frame body 11.

In the embodiment described above, the wall members 18, 19, which are formed separately from the frame body 11, are fixed to the frame body 11, but a wall portion corresponding to the wall members 18, 19 may be formed integrally with the frame body 11. In other words, in the embodiment described above, a wall portion corresponding to the wall members 18, 19 may be formed in the enclosure 4.

In the embodiment described above, the entire frame body 11 may be a conductive member. For example, the entire frame body 11 may be formed of a resin material with conductivity. Moreover, in the embodiment described above, the entire edge of the opening portion 11a is formed of the grounded conductive member 20, but a part of the edge of the opening portion 11a may be formed of a grounded conductive member. In this case, the edge of the opening portion 11a, except the part formed of the conductive member, is formed of an insulating member. Moreover, in the embodiment described above, the entire edge of the opening portion 11a may be formed of the insulating material. In this case, for example, a conductive member to release static electricity emitted from the user may be attached to the enclosure 4 at a spot other than the edge of the opening portion 11a.

In the embodiment described above, the optical axis L1 of the light emitted from the display surface 6a and the optical axis L2 of the light reflected by the beam splitter 8 does not need to be orthogonal. Moreover, in the embodiment described above, the display mechanism 6 may be disposed at a position where a part of the display mechanism 6 is contained in the field of view of the user viewing the aerial image formed in the aerial-image display region R. Furthermore, in the embodiment described above, the display surface 6a may face diagonally upward.

In the embodiment described above, the aerial image display device 2 does not have to include the shutter member 14 or the shutter drive mechanism 15, nor does it have to include the fan 16. Moreover, in the embodiment described above, the detection mechanism 3 may be a capacitance sensor or may be a motion sensor. Furthermore, the detection mechanism 3 may be constituted by two cameras. Furthermore, in the embodiment described above, the aerial image display device 2 may be used with devices other than the input device 1. The above description relates to specific examples according to the present invention, and various modifications are possible without departing from the spirit of the present invention. The appended claims are intended to cover such applications within the true scope and spirit of the invention.

### DESCRIPTION OF REFERENCE NUMERALS

1 Input device
2 Aerial-image display device
3 Detection mechanism
4 Enclosure
6 Display mechanism
6a Display surface
7 Aerial-image forming mechanism
8 Beam splitter
9 Retroreflective material
11 Frame body
11a Opening portion
12 Input portion
14 Shutter member
14A Closed position
14B Open position
15 Shutter drive mechanism
16 Fan
18, 19 Wall member (wall portion)
20 Conductive member
R Aerial-image display region

1. An aerial image display device, comprising:
a display mechanism having a display surface which displays an image, an aerial-image forming mechanism which forms an image as an aerial image by projecting the image displayed on the display surface into a space, and an enclosure in which the display mechanism and the aerial-image forming mechanism are accommodated, wherein
in the enclosure, a wall portion rising from at least a part of a periphery of an aerial-image display region, which is a region in which the aerial image is formed, is formed or fixed.

2. The aerial image display device according to claim 1, wherein
the enclosure includes a frame body surrounding the aerial-image display region;
an inner peripheral side of the frame body is an opening portion leading to an inside of the enclosure; and
the wall portion is formed on or fixed to the frame body.

3. The aerial image display device according to claim 2, wherein
the opening portion has a rectangular or regular-square shape; and
the wall portion is disposed along an edge of the opening portion and surrounds the opening portion from four or three directions.

4. The aerial image display device according to claim 2, further comprising:
a shutter member for closing the opening portion; and
a shutter drive mechanism moving the shutter member between a closed position where the opening portion is closed and an open position where the opening portion is opened.

5. The aerial image display device according to claim 1, further comprising:
a fan which is disposed inside the enclosure and circulates air inside the enclosure.

6. The aerial image display device according to claim 1, wherein
the aerial-image forming mechanism includes a beam splitter which reflects a part of light emitted from the display surface and a retroreflective material to which the light reflected by the beam splitter is incident and which reflects the incident light in the same direction as an incident direction toward the beam splitter;
after reflecting the light by the retroreflective material, the aerial image is formed by light transmitted through the beam splitter in the aerial-image display region; and
the display surface faces diagonally downward.

7. The aerial image display device according to claim 6, wherein
the beam splitter is formed as a flat plate and reflects, diagonally downward, a part of the light emitted from the display surface;
the retroreflective material reflects the incident light diagonally upward; and
the display mechanism is disposed at a position out of a field of view of a user viewing the aerial image.

8. An input device inputting information using a user's fingertip, the input device comprising:
the aerial image display device according to claim 1 and a detection mechanism detecting a position of the user's fingertip in the aerial-image display region, wherein
the aerial-image display region is an input portion for the user to input the information.

9. The input device according to claim 8, wherein
the enclosure includes a frame body surrounding the aerial-image display region;
an inner peripheral side of the frame body is an opening portion leading to an inside of the enclosure and is also the input portion; and
at least a part of an edge of the opening portion is formed of a grounded conductive member.
